(19) United States
(12) Patent Application Publication
(10) Pub. No.: US 2024/0354751 A1
(43) Pub. Date: Oct. 24, 2024

(54) CROSS-PLATFORM RECORD MANAGEMENT USING A PEER-TO-PEER LINK SERVICE

(71) Applicant: MASTERCARD ASIA/PACIFIC PTE. LTD., Singapore (SG)

(72) Inventors: Teck Yong TAN, Singapore (SG); Alan JOHNSON, Maldon (GB); Donghao HUANG, Singapore (SG); Ian QUEK, Singapore (SG); Jinjing JIANG, Singapore (SG); Phuoc Hoang Long LE, Singapore (SG); Zhijian XIE, Singapore (SG)

(21) Appl. No.: 18/640,812

(22) Filed: Apr. 19, 2024

Related U.S. Application Data
(60) Provisional application No. 63/497,197, filed on Apr. 19, 2023.

(51) Int. Cl. G06Q 20/38

(52) U.S. Cl. CPC G06Q 20/3825

(57) ABSTRACT

A computerized system and method for processing record change requests across multiple applications is provided. A link is received from a first application, the link being associated with a record change request from a first account. A signed token is obtained from a like service using the link, wherein the signed token includes identity data associated with the first account and the record change request. An indicator of a second application is received, wherein the second application is chosen by a user for interacting with the record change request. Further, account information of a second account associated with the user is received. The second application is caused to be executed using the signed token and the indicator of the second application, wherein the second application updates a record at the second account associated with the user in response to the record change request.

### BACKGROUND

In the current electronic communication environment, some popular messaging apps open any link in their embedded web viewing interface by default. Some of these messaging apps enable the user to switch off this default behavior, while others do not. Additionally, or alternatively, some messaging apps are configured for different behavior depending on what types of links are received. For example, verified links are automatically opened in a corresponding app for a more streamlined and faster user experience, while non-verified links (e.g., deep links) are opened using the default browser application instead of showing an app selection dialog interface. In other examples, an app selection dialog interface is shown that enables the user to select the default browser application or another application in which to open the link.

Further, in some examples, a messaging app and/or an associated operating system are configured to prevent a user from choosing from multiple applications on the device which map to the same universal link schema. Activating a universal link will open the app that is listed first in an app site association file (e.g., Apple App Site Association (AASA)). In some such examples, the only way for user to change this behavior is to uninstall the higher priority app.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for processing record change requests across multiple applications is described. A link is received from a first application, the link being associated with a record change request from a first account. A signed token is obtained from a like service using the link, wherein the signed token includes identity data associated with the first account and the record change request. An indicator of a second application is received, wherein the second application is chosen by a user for interacting with the record change request. Further, account information of a second account associated with the user is received. The second application is caused to be executed using the signed token and the indicator of the second application, wherein the second application updates a record at the second account associated with the user in response to the record change request.

### BRIEF DESCRIPTION OF THE DRAWINGS

The present description will be better understood from the following detailed description read considering the accompanying drawings, wherein:

FIG. 1 is a block diagram illustrating a system configured to enable payments between payers and payees using differing payment apps;

FIG. 2 is a flowchart illustrating a method for processing a payment from a payer using a first type of payment app to a payee using a second type of payment app;

FIG. 3 is a diagram illustrating a method for sending money using a paylink service app and a messaging app;

FIGS. 4A-B are diagrams illustrating a method for receiving money using a Paylink service-associated website;

FIG. 5 includes diagrams illustrating a method for receiving money using a Paylink service-enabled app;

FIG. 6 is a diagram illustrating a method for requesting money using a Paylink service QR code in a first type of OS;

FIG. 7 is a diagram illustrating methods for using QR codes with the described paylink service;

FIG. 8 is a diagram illustrating a method for sending a P2P payment using the Paylink service;

FIG. 9 is a diagram illustrating a method for requesting money by sharing a paylink using social channels;

FIG. 10 is a diagram illustrating a method for paying a bill by scanning a Paylink service-based QR code generated by a biller;

FIG. 11 is a diagram illustrating a method for sending a P2P payment using the Paylink service; and

FIG. 12 illustrates an example computing apparatus as a functional block diagram for executing the instructions described herein.

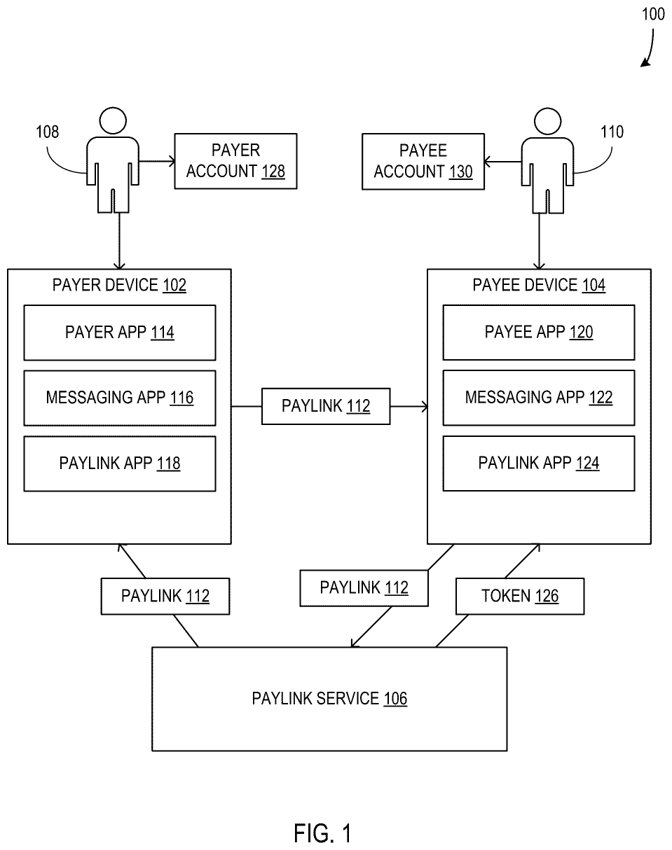

Corresponding reference characters indicate corresponding parts throughout the drawings. In FIGS. 1 to 12, the systems are illustrated as schematic drawings. The drawings may not be to scale. Any of the figures may be combined into a single example or embodiment.

### DETAILED DESCRIPTION

Because the complex deep linking behaviors of various devices, operating systems, and/or messaging apps are controlled independently and are out of control of a link sender, the disclosure is configured to provide a better and more consistent user experience across all major messaging apps and/or on all major operating systems and devices. The disclosure is configured to reduce conventional link sharing, for which is difficult or impossible to provide consistent behavior, and it is configured to provide a link processing service that can enable shared links to be processed in a consistent manner. For instance, in some examples, the disclosure includes a hosted uniform resource locator (URL) shortener service to facilitate the exchange of non-sensitive data between a sender and a receiver when the sender is requesting a record change of the receiver via shared link data. Further, in some examples, the disclosure describes hosted webpages that act as fallback mechanisms for app links and/or universal links that need to be managed.

In some examples, the disclosure describes a hosted web flow that allows users to complete record change transactions associated with accounts by entering account information and personal details. Such a web flow makes it unnecessary to develop separate native apps for each operating system (OS) ecosystem and provides a single, consistent interface that can be displayed and used on a wide variety of different devices, including mobile devices, desktop computers, or the like. Further, such a web flow enables potential integration with other features, such as “click-to-pay”, and the ability to create better user experience (UX) behavior. Thus, the data storage and processing resources used to download and install additional applications is reduced when compared to other flows that enable payments and/or other record changes between users.

In some examples, the disclosure includes public application program interfaces (APIs) for partners. The APIs include APIs for the generation of short links that enable access to the link processing service, APIs for getting public keys of the described link processing service, and/or APIs for registering and/or updating apps that are compatible with the described link processing service (e.g., registering and/or updating names, icons, OS schemes, partner's public certificate, server endpoint URLs, Originating Institution's (OI) public keys, and/or other information about compatible apps).

In some examples, the disclosure is configured for the mapping of Quick Response (QR) schemes and merchant identifiers. For instance, in some examples, receiving/biller banks are enabled to provide mappings of various local QR schemes and associated entity IDs to entity IDs (e.g., virtual account numbers for receiving requests only) that are associated with the disclosed link processing service.

In some examples, the disclosure is configured to provide private APIs for direct-to-consumer (D2C) apps that are made to be compatible with the described link processing service. For instance, in some examples, these APIs include APIs for exchanging paylinks, APIs for decrypting tokens (e.g., Java Web Tokens (JWTs)) from an app provider, APIs for adding app provider public key cryptography (PKC) and endpoint data, APIs for signing tokens with a private key of the described link processing service, and APIs for profile/session management for compatible app instances.

In some examples, the disclosure is configured to provide public key infrastructure. For instance, in some examples, the public key infrastructure enables the maintenance of Public Key Infrastructure (PKI) data for all app providers (e.g., public certificates, OI public keys), the infrastructure establishes a certification authority (CA) for signing app provider certificate signing requests (CSRs), along with related support, and/or the infrastructure enables app providers to get PKC data from the described service APIs to verify access tokens used during Peer-to-Peer (P2P) backend communications.

In some examples, the disclosure is configured to provide API security, including providing security features that meet prevailing security standards.

In some examples, the disclosure is configured to host a website for fallback workflows, including allowing payment flows to be completed within messaging apps using an internal web view interface to open paylinks.

In some examples, the disclosure is configured to include a D2C mobile app that has versions that are compatible with multiple devices and/or OSes. In such examples, the D2C mobile app is configured to integrate with the APIs described herein.

In some examples, the disclosure is configured to issue certificates to app providers after receiving CSRs from the app providers. The app providers register compatible apps with the described link processing service (e.g., including a name, icon, and/or OS scheme), provides its own public certificate and server endpoint, and/or a public certificate of the OI to the described service via API or other means.

In some examples, the disclosure is configured to integrate with biller banks to provide mappings of QR schemes and/or merchant IDs to merchant IDs associated with the described link processing service.

In some examples, the disclosure is configured to enable a payer app provider to integrate with APIs of the described link processing service such that the payer app can create a short paylink, store transfer data mapped to unique paylink slugs, verify paylink token payloads according to technical specifications, and/or provide APIs to payee app provider counter parties, such as APIs for updating payee data for Peer to Peer (P2P) transfer.

In some examples, the disclosure is configured to enable a payee app provider to integrate with APIs of the described link processing service such that the payee app can create a short paylink, generate a paylink token payload for P2P according to technical specifications, store transfer data mapped to unique paylink slugs, and/or provide APIs to Payer App Provider counterparties, including an API for request money transfer accepted (e.g., for the payer app provider to mark the related request money transfer as accepted, and to get payee Payment Card Information (PCI)/Personally Identifiable Information (PII) data), and/or an API for notifying the counterparties of P2P transfer status.

In some examples, the disclosure is configured to provide security for APIs hosted by app providers, including Mutual Transport Layer Security (MTLS)—transport level encryption, creating access tokens for accessing counterparty APIs, and/or verifying tokens from inbound requests (e.g., app providers need to get service public keys for verifying token signatures and/or for velocity checks).

In some examples, the disclosure is configured to use paylinks that are usable by a variety of different devices, OSes, and/or associated apps, such as messaging apps and/or payment apps. In some such examples, the payer does not know what the payee will use to open and/or process the paylink and so cannot specify details relating to platform or app in the link so that the right app is automatically launched when the Payee opens the link. The Payee also needs to have the freedom to choose the app for processing the link. The Payee could be a first-time user or already have a preferred app.

Further, in some examples, the paylinks used as described herein are configured to provide useful information when displayed within an app, such as a messaging app. Most messaging apps include the URL in its entirely for display with its preview. Open Graph tags (e.g., og:title, og:type, og:image, og:description, og:url) can be used to customize the preview image/text.

In some examples, the disclosure is configured to use both unverified app links or unverified universal links (e.g., deep links) and verified app links or verified universal links. For the verified links, the apps are configured to register handling the links but do not request verification. For the unverified links, the apps are configured to register handling the links and to request verification of domain ownership.

In some examples, the disclosure is configured to enable an app chooser for selecting how links are processed. The initial design of having multiple service-enabled apps register/map to the same URL does not allow the end user to choose which app to handle P2P/bill payments due to the way Universal/App Links work in an OS (e.g., iOS/Android 12+). In some such examples, a consistent way to address this UX deficiency has been designed and implemented The service D2C app is configured as the only app registered/mapped to the paylink.

In some examples, the service D2C app requires service-enabled apps to register and handle a custom action for the service such as “com.PAYLINK”. Further, the service app will query the OS for apps registered to handle the custom action after being launched by opening the paylink. If at least one matching app is identified, the D2C app starts an activity with the custom action and the OS displays an App Chooser. The user can select the app and make it the default. However, if no match is identified, the D2C app handles the paylink directly.

Alternatively, or additionally, in some examples, the D2C app requires the definition of custom URL schemes in service-enabled apps like Partner Bank (com.partnerbank) and Partner Wallet (com.partnerwallet). Further, the D2C app will check if any service-enabled app is installed, it will show the customized (coded) App Chooser View containing all service-enabled apps for the user to choose. Otherwise, the paylink will be handled by the D2C App directly.

In some examples, the disclosure is configured to exclude messaging apps that are known to open links in internal web view interfaces by default from the App Chooser interface. Additionally, and/or alternatively, the disclosure is configured to display contextual instructions when the associated website is loaded using these messaging apps (e.g., if it can be determined which app is being used to open the service website).

FIG. 1 is a block diagram illustrating a system 100 configured to enable payments between payers and payees using differing payment apps. In some examples, the system 100 includes a payer device 102 of a payer 108, a payee device 104 of a payee 110, and a paylink service 106. The paylink service 106 (e.g., the described link processing service) is configured to communicate with and/or interact with the payer device 102 and payee device 104 to facilitate a payment transaction from the payer 108 to the payee 110. The paylink service 106 is configured to provide the payer device 102 with a paylink 112. The payer device 102 provides the paylink 112 to the payee device 104 to initiate the payment. And the payee device 104 exchanges the paylink 112, with the paylink service 106, for a token 126 that further enables the payment to be processed from a payer account 128 to a payee account 130. The payer device 102 is configured to use at least one of a payer app 114, a messaging app 116, and/or a paylink app 118 during the payment transaction, while the payee device 104 is configured to use at least one of a payee app 120, a messaging app 122, and/or a paylink app 124 during the payment transaction. It should be understood that, in some examples, the payment transaction is performed between the payer app 114 and the payee app 120 and the payer app 114 differ from and is otherwise incompatible with the payee app 120 (e.g., the payer app 114 is configured to send payments to others that are using the same app or type of app and/or the payee app 120 is configured receive payments from others that are using the same app or type of app).

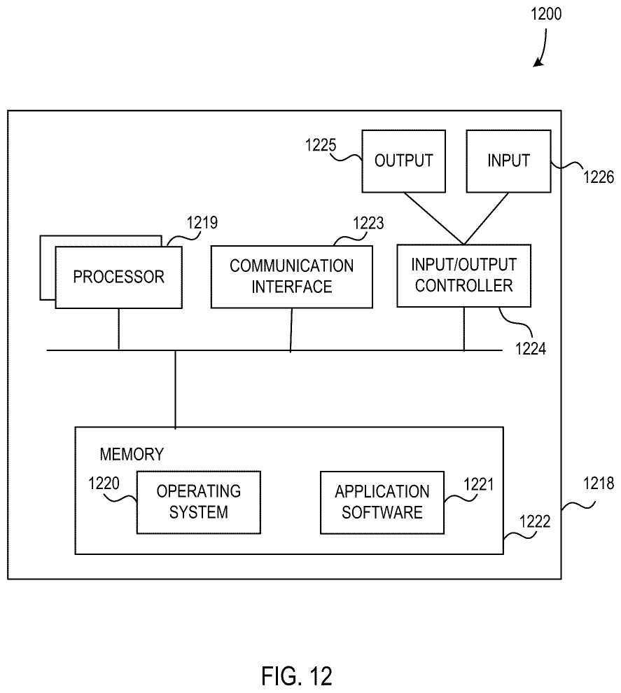

In some examples, the system 100 includes a computing device, such as the computing device of FIG. 12. Further, in some examples, the system 100 includes multiple computing devices that are configured to communicate with each other via one or more communication networks (e.g., an intranet, the Internet, a cellular network, other wireless network, other wired network, or the like). In some such examples, entities of the system 100 are configured to be distributed between the multiple computing devices and to communicate with each other via network connections. For instance, in an example, the payer device 102, the payee device 104, and the paylink service 106 are located and/or executed on separate computing devices. The paylink service 106 is configured to be executed on one or more computing devices and to facilitate the payment transaction between the computing devices of the payer device 102 and payee device 104 via a communication network as described herein. In other examples, other arrangements or organizations of multiple computing devices are used in the system 100 without departing from the description.

In some examples, the payer device 102 and/or the payee device 104 are mobile devices such as smart phones. Alternatively, or additionally, one or both of the payer device 102 and the payee device 104 are other types of computing devices, such as personal computers, tablets, or the like. In other examples, other types of computing devices are used in the system 100 without departing from the description.

In some examples, the paylink 112 that is passed between the payer device 102 and the payee device 104 includes data that enables the devices 102-104 to setup and complete a transaction without having compatible payment apps on both devices. In some such examples, the paylink 112 includes link data that enables a receiver of the paylink 112 to navigate to a web portal or otherwise navigate to data that is specific to the payment transaction that has been initiated. Such data includes data identifying the payer application instance, the payer device 102, and/or the payer 108 by some form of identification, data identifying the app used to initiate the payment, and/or data identifying a payer account 128 and/or an entity associated with the payer account 128. Additionally, or alternatively, the paylink 112 can be provided in a variety of formats, such as in a Uniform Resource Locator (URL) or a Quick Response (QR) code, as described herein. In other examples, the paylink 112 and associated data stored by the paylink service 106 includes more, fewer, and/or different types of data without departing from the description.

Additionally, in some examples, the token 126 is a signed token that facilitates the processing and/or performance of a payment transaction between the payer account 128 and the payee account 130 based on information provided via the paylink 112 (e.g., information from the payer 108, such as the quantity of the payment and source account of the payment, or the like) and information provided by the payee 110 in response to receiving the paylink 112 (e.g., information such as the app to be used to process the payment, the target payee account 130 to which the payment is to be directed, or the like).

Further, in some examples, the payer app 114 and/or payee app 120 are apps that are configured to enable users to send payments to other users with the same or similar apps. The messaging apps 116 and 122 are apps that are configured to enable users to send messages to other users, and the paylink apps 118 and 124 are apps that are configured to interact with the paylink service 106 to facilitate payments between the payer device 102 and payee device 104 as described herein. In some examples, the paylink apps 118 and 124 on the payer device 102 and the payee device 104, respectively, are instances of the same application. Further details and/or examples of such apps are provided below.

Additionally, or alternatively, in other examples, a payment is initiated by the payee 108 via a request for payment, which also makes use of the paylink service 106 and an associated paylink 112. Some examples of such payee-initiated payments are described in greater detail below.

In some examples, the payment includes the transfer of funds and/or associated data from an entity that manages or is otherwise associated with the payer account 128 (e.g., a bank or other credit issuer) to an entity that manages or is otherwise associated with the payee account 130 (e.g., a bank or other credit acquirer). In some such examples, the token 126 is signed and/or configured for use during one or more steps of the payment processing, such as during authorization, authentication, settlement, and/or clearing. In other examples, the token 126 is used in other ways to facilitate the payment without departing from the description.

In some examples, the system 100 is more generally associated with using a link service (e.g., the paylink service 106) to process generic record change requests associated with two separate accounts. In some such examples, the system 100 is configured to receive a link from a first application, the link being associated with a record change request from a first account; obtain a signed token from a link service using the link, wherein the signed token includes identity data associated with the first account and the record change request; receive an indicator of a second application chosen by a user for interacting with the record change request and account information of a second account associated with the user; and cause the second application to be executed using the signed token and the indicator of the second application, wherein the second application updates a record at the second account associated with the user in response to the record change request.

Further, in some such examples, the first application is of a first application type and the second application is of a second application type and wherein the first application type and the second application type are not compatible.

Additionally, or alternatively, the system 100 is configured to display the link to the user using an interface of a user device; and receive an indication from the interface that the link has been activated, wherein obtaining the signed token is based on the link being activated.

In some such examples, the system 100 is configured to display at least one application that is compatible with the link service using an interface of a user device; and prompt the user to select an application from the displayed at least one application, wherein the second application indicator is received in response to the prompt.

Additionally, or alternatively, receiving the link includes scanning a QR code that includes data of the link with an optical device of a user device; obtaining the signed token using the received link, receiving an indicator of the second application, and causing the chosen second application to be launched is performed using a website associated with a paylink service; and/or obtaining the signed token using the received link, receiving the indicator of the second application, and causing the chosen second application to be launched is performed using a link service application.

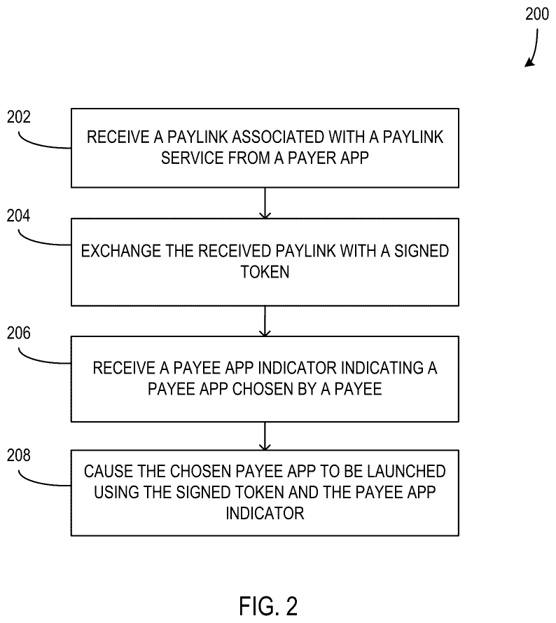

FIG. 2 is a flowchart illustrating a method 200 for processing a payment from a payer using a first type of payment app to a payee using a second type of payment app. In some examples, the method 200 is performed in a system such as system 100 of FIG. 1.

At 202, a paylink (e.g., paylink 112) associated with a paylink service (e.g., paylink service 106) is received from a payer app (e.g., payer app 114). In some examples, the paylink is received on a payee device via a messaging app or from the payee app directly. Further, in some such examples, the paylink is received in the form of a URL and/or a QR code that can then be activated or otherwise used by apps of the payee device.

At 204, the received paylink is exchanged with a signed token (e.g., token 126). In some examples, the exchange of the paylink for the signed token is performed through communication with the paylink service 106. In some such examples, the exchange includes verification of the paylink based on information stored by the paylink service 106. In some examples, the paylink is exchanged for the token as a result of the paylink being displayed using an interface of a payee device and receiving an indication from the interface that the paylink has been activated.

At 206, a payee app indicator indicating a payee app (e.g., payee app 120) chosen by the payee (e.g., payee 110) is received. In some examples, the payee app indicator is received as a result of at least one payee app that is compatible with the paylink service is displayed using an interface of the payee device and the payee being prompted to select a payee app from the displayed at least one payee app, wherein the payee app indicator is received in response to the prompt.

At 208, the chosen payee app is caused to be launched using the signed token and the payee app indicator, wherein a transaction associated with the paylink is enabled between a payer account (e.g., payer account 128) and a payee account (e.g., payee account 130) associated with the payee. Further, in some examples, the chosen payee app is caused to be launched by a website associated with the paylink service that is accessed by the payee device. Alternatively, or additionally, in some examples, the chosen payee app is caused to be launched by a paylink service app that is specifically configured to interact with the paylink service.

Additionally, or alternatively, in some examples, the method 200 is configured to more generally use a link service to process record change requests between two accounts, as described above with respect to system 100.

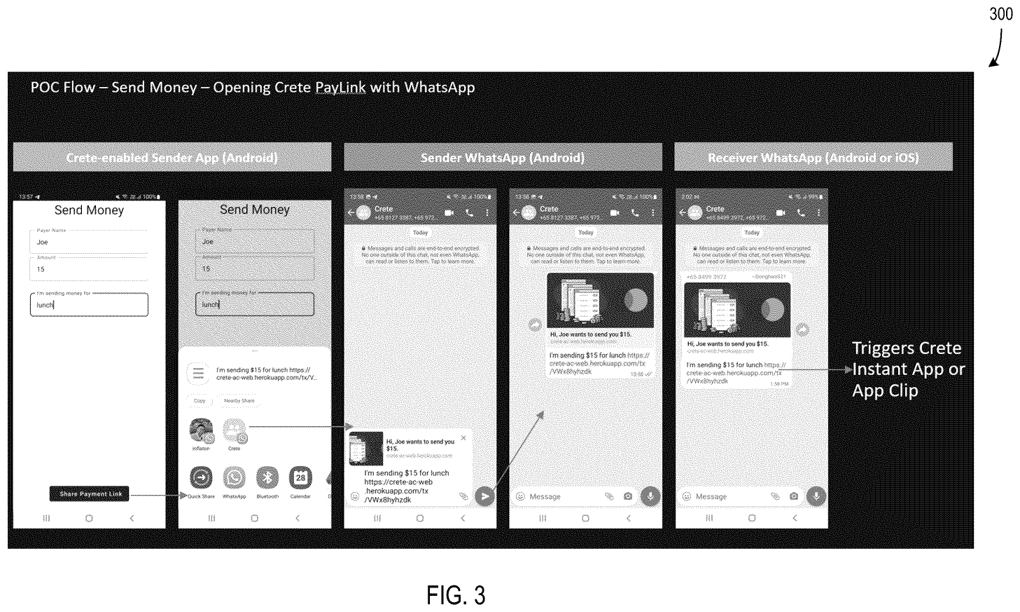

FIG. 3 is a diagram illustrating a method 300 for sending money using a paylink service app and a messaging app. In some examples, the method 300 is executed or otherwise performed in a system such as system 100 of FIG. 1. It should be understood that “Crete” is a name for an exemplary implementation of the described paylink service throughout this document.

The method 300 includes selecting to send a payment to a payee using a Paylink service-enabled Sender App. The Sender App enables the sending of a Payment Link (e.g., paylink 112) via a messaging app of the sender/payer. The Payment Link is sent to the payee and is displayed in the payee's messaging app. In this case, the messaging apps of the payer and the payee are of the same type. The payee activating the Payment Link triggers the launching of a Paylink service Instant App or App Clip.

Further, in some examples, a method for sending money using a Paylink service-based instant app is included in or associated with the method 300. This method includes the receiver of the payment being prompted to use a Paylink service Instant App, including agreeing to Terms of Service. The receiver is then enabled to open the Paylink service Instant App and continue or otherwise to download an associated Paylink service App.

Additionally, or alternatively, described methods include a method for sending money using a Paylink service-based app clip. In some examples, this method is executed or otherwise performed in a system such as system 100 of FIG. 1. Further, in some examples, the method occurs after the method 300 of FIG. 3. This method includes the receiver of the payment being prompted to use a Paylink service App Clip. The receiver is then enabled to continue with the App Clip or to download an associated Paylink service App to access other features.

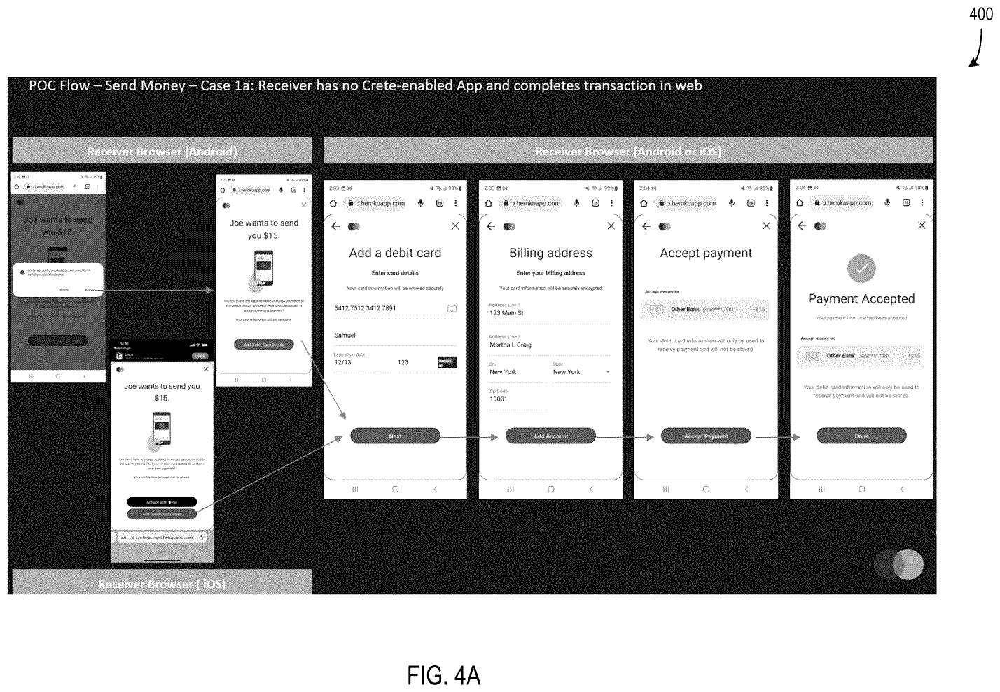

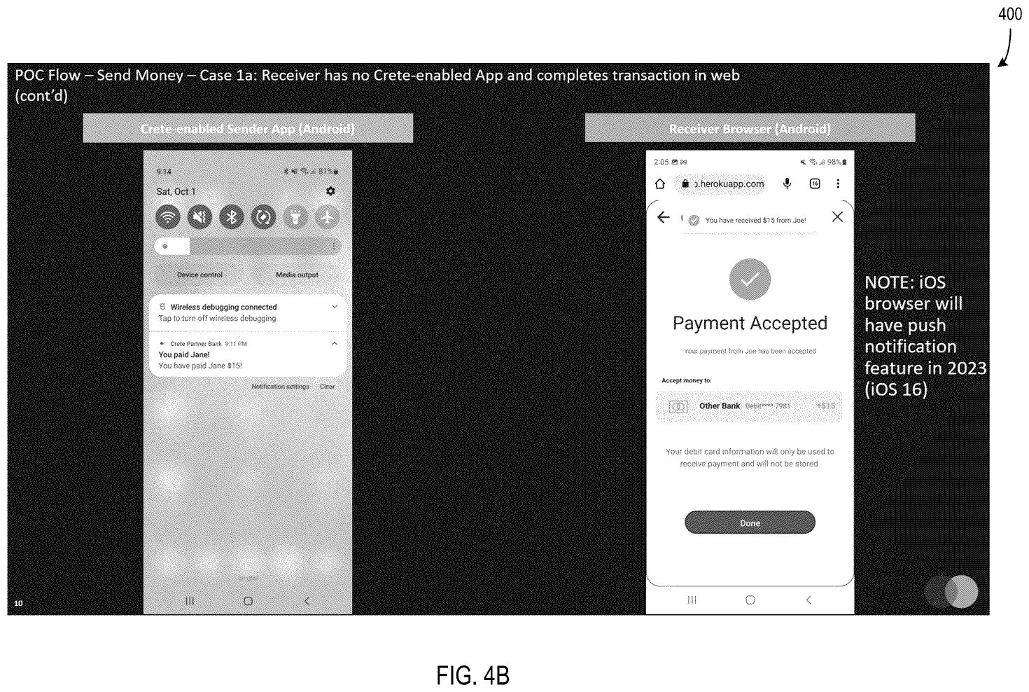

FIGS. 4A-B are diagrams illustrating a method 400 for receiving money using a Paylink service-associated website. In some examples, the method 400 is executed or otherwise performed in a system such as system 100 of FIG. 1.

The method 400 in FIG. 4A includes notifying the payee that the payer wants to send a payment via a web browser interface. The payee is enabled to input data associated with the account to which the payment will be directed. Further, the payee is enabled to input other personal data, such as address information. The payee is then enabled to accept or otherwise confirm that the payment should proceed using the data the payee provided.

The continued method 400 in FIG. 4B includes notifying the payer that the payment has occurred through a notification on the payer's device. Further, the payee is notified that the payment has occurred and/or that they have received money associated with the payment.

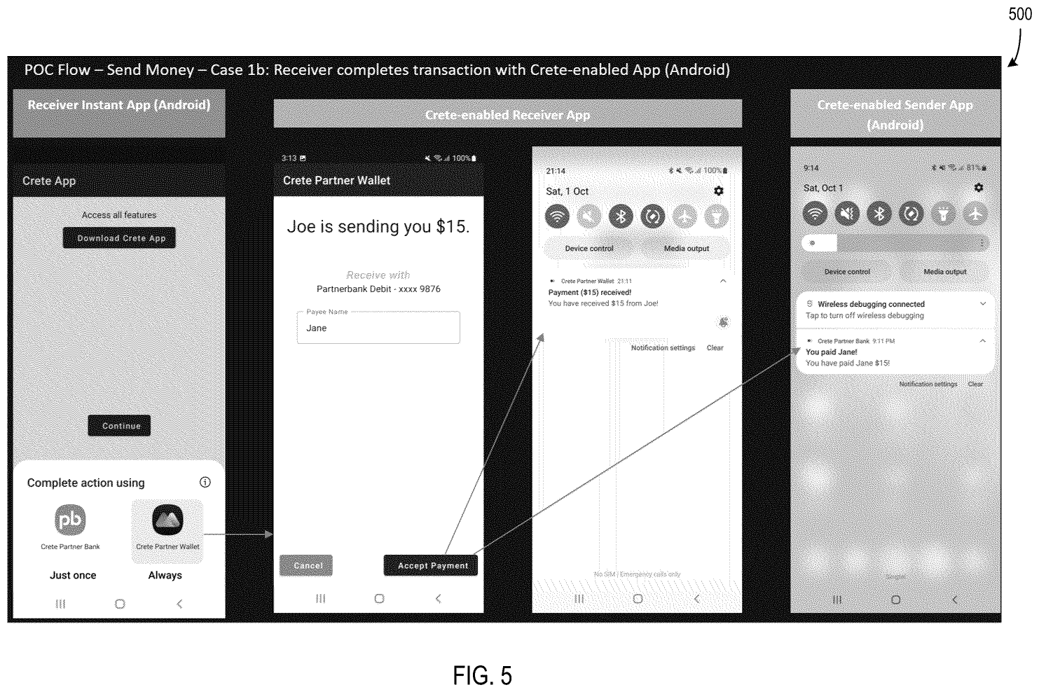

FIG. 5 includes diagrams illustrating a method 500 for receiving money using a Paylink service-enabled app. In some examples, the method 500 is executed or otherwise performed in a system such as system 100 of FIG. 1.

The method 500 in FIG. 5 includes notifying the payee that the payer wants to send a payment via a Paylink service-enabled app in a first type of OS (e.g., Android). The payee is enabled to accept the payment via the app. In some examples, the Paylink service-enabled app stores the account information and/or other identifying information of the payee, such that they do not have to enter this information at this point. The payer and payee are then notified that the payment has occurred via their respective devices (e.g., a notification is provided to the payee through the OS of the first type). In other examples, the method 500 is performed using apps in other types of OS (e.g., iOS) without departing from the description.

In some examples, the described methods include a method for receiving money using a Paylink service app. In some examples, the method is executed or otherwise performed in a system such as system 100 of FIG. 1. The method includes notifying the payee that the payer wants to send a payment via a Paylink service app in a first type of OS (e.g., Android). The payee is enabled to accept the payment via the app. In some examples, the Paylink service app stores the account information and/or other identifying information of the payee, such that they do not have to enter this information at this point. The payer and payee are then notified that the payment has occurred via their respective devices (e.g., a notification is provided to the payee through the OS of the first type). Additionally, or alternatively, the method includes notifying the payee that the payer wants to send a payment via a Paylink service app in a second type of OS (e.g., iOS). The payee is enabled to accept the payment via the app. In some examples, the Paylink service app stores the account information and/or other identifying information of the payee, such that they do not have to enter it at this point. The payer and payee are then notified that the payment has occurred via their respective devices (e.g., a notification is provided to the payee through the OS of the second type).

In some examples, the described methods include a method for receiving money using a Paylink service app while having access to both a Paylink service-enabled app and the Paylink service app. In some examples, the method is executed or otherwise performed in a system such as system 100 of FIG. 1. The method includes notifying the payee that the payer wants to send a payment via a Paylink service app in a first type of OS (e.g., Android). The payee is enabled to accept the payment and prompted to select the app with which the payment will be handled. The payee selects the Paylink service app. In some examples, the Paylink service app stores the account information and/or other identifying information of the payee, such that they do not have to enter it at this point. The payer and payee are then notified that the payment has occurred via their respective devices (e.g., a notification is provided to the payee through the OS of the first type). Additionally, or alternatively, the method includes notifying the payee that the payer wants to send a payment via a Paylink service app in a second type of OS (e.g., iOS). The payee is enabled to accept the payment and prompted to select the app with which the payment will be handled. The payee selects the Paylink service app. In some examples, the Paylink service app stores the account information and/or other identifying information of the payee, such that they do not have to enter it at this point. The payer and payee are then notified that the payment has occurred via their respective devices (e.g., a notification is provided to the payee through the OS of the second type).

In some examples, the described methods include a method for receiving money using a Paylink service-enabled app while having access to both the Paylink service-enabled app and a Paylink service app. In some examples, the method is executed or otherwise performed in a system such as system 100 of FIG. 1. The method includes notifying the payee that the payer wants to send a payment via a Paylink service app in a first type of OS (e.g., Android). The payee is enabled to accept the payment and prompted to select the app with which the payment will be handled. The payee selects the Paylink service-enabled app. In some examples, the Paylink service-enabled app stores the account information and/or other identifying information of the payee, such that they do not have to enter it at this point. The payer and payee are then notified that the payment has occurred via their respective devices (e.g., a notification is provided to the payee through the OS of the first type). Additionally, or alternatively, the method includes notifying the payee that the payer wants to send a payment via a Paylink service app in a second type of OS (e.g., iOS). The payee is enabled to accept the payment and prompted to select the app with which the payment will be handled. The payee selects the Paylink service-enabled app. In some examples, the Paylink service-enabled app stores the account information and/or other identifying information of the payee, such that they do not have to enter it at this point. The payer and payee are then notified that the payment has occurred via their respective devices (e.g., a notification is provided to the payee through the OS of the second type).

In some examples, the described methods include a method for activating a paylink using a messaging app in a first type of OS. In some examples, the method is executed or otherwise performed in a system such as system 100 of FIG. 1. In some examples, the method includes the payer accessing a Paylink service-enabled app and selecting to send a payment to the payer via a messaging app. The payee receives a paylink from the payer via the messaging app in the first type of OS (e.g., Android). The payee activates the link and is enabled to select whether to use a Paylink service Instant App or a Paylink service App to handle the payment process.

In some examples, the described methods include a method for activating a paylink using a messaging app in a second type of OS. In some examples, the method is executed or otherwise performed in a system such as system 100 of FIG. 1. In some examples, the method includes the payer accessing a Paylink service-enabled app and selecting to send a payment to the payer via a messaging app. The payee receives a paylink from the payer via the messaging app in the second type of OS (e.g., iOS). The payee activates the link and is enabled to select whether to use a Paylink service App Clip or a Paylink service App to handle the payment process. It should be understood that, in some examples such as those described above, some applications open links in internal web browsers and it takes some additional processes to cause those applications to hand off link opening to the OS of the device so that an application associated with the described paylink systems can be launched.

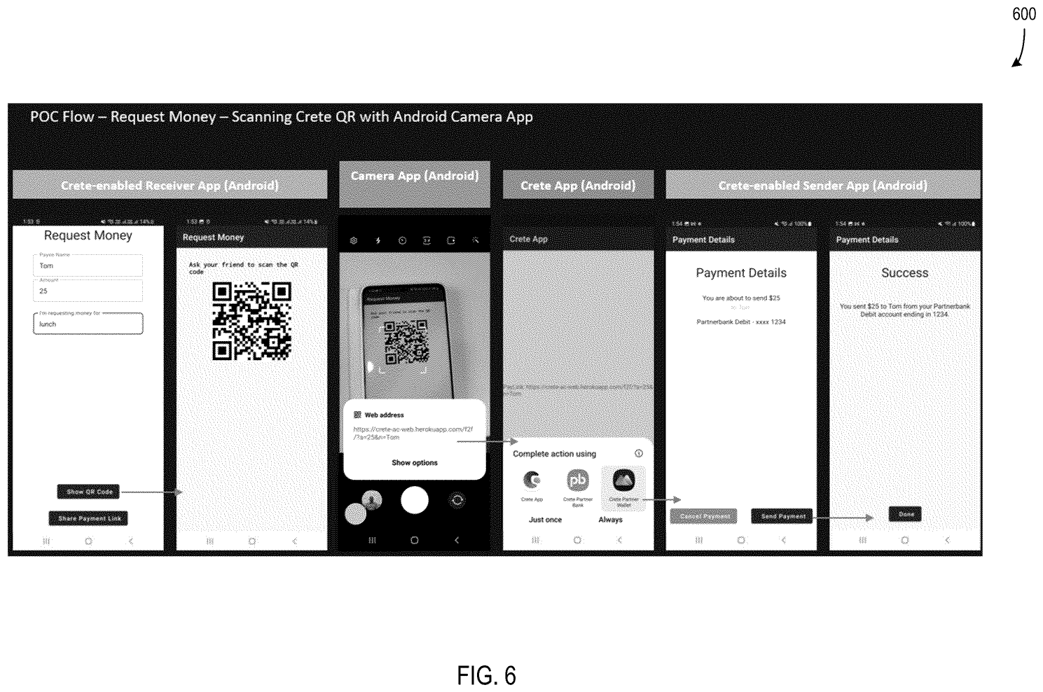

FIG. 6 is a diagram illustrating a method 600 for requesting money using a Paylink service QR code in a first type of OS. In some examples, the method 600 is executed or otherwise performed in a system such as system 100 of FIG. 1.

In some examples, method 600 includes the payee requesting to receive a payment from the payer and then choosing to display the paylink as a QR code for scanning by the payee. The payee uses a camera app in the first type of OS (e.g., Android). The payee's device processes the QR code and prompts the payee to select an app with which the paylink will be processed. The payee selects a Paylink service-enabled app and the payment is processed.

In some examples, the described methods include a method for requesting money using a Paylink service QR code in a second type of OS. In some examples, the method is executed or otherwise performed in a system such as system 100 of FIG. 1. In some examples, method includes the payee requesting to receive a payment from the payer and then choosing to display the paylink as a QR code for scanning by the payee. The payee uses a camera app in the second type of OS (e.g., iOS). The payee's device processes the QR code and prompts the payee to select an app with which the paylink will be processed. The payee selects a Paylink service-enabled app and the payment is processed.

In some examples, the described methods include a method for requesting money using a paylink in a messaging app in a first type of OS. In some examples, the method is executed or otherwise performed in a system such as system 100 of FIG. 1. In some examples, the method includes the payee selecting to send a payment request to the payer and then choosing to send the paylink as a link in a messaging app for activation by the payer. The payer views the paylink in a messaging app and activates it in the first type of OS (e.g., Android). The payer's device prompts the payer to select an app with which the paylink will be processed. The payer selects a Paylink service-enabled app and the payment is processed.

In some examples, the described methods include a method for requesting money using a paylink in a messaging app in a second type of OS. In some examples, the method is executed or otherwise performed in a system such as system 100 of FIG. 1. In some examples, the method includes the payee selecting to send a payment request to the payer and then choosing to send the paylink as a link in a messaging app for activation by the payer. The payer views the paylink in a messaging app and activates it in the second type of OS (e.g., iOS). The payer's device prompts the payer to select an app with which the paylink will be processed. The payer selects a Paylink service-enabled app and the payment is processed.

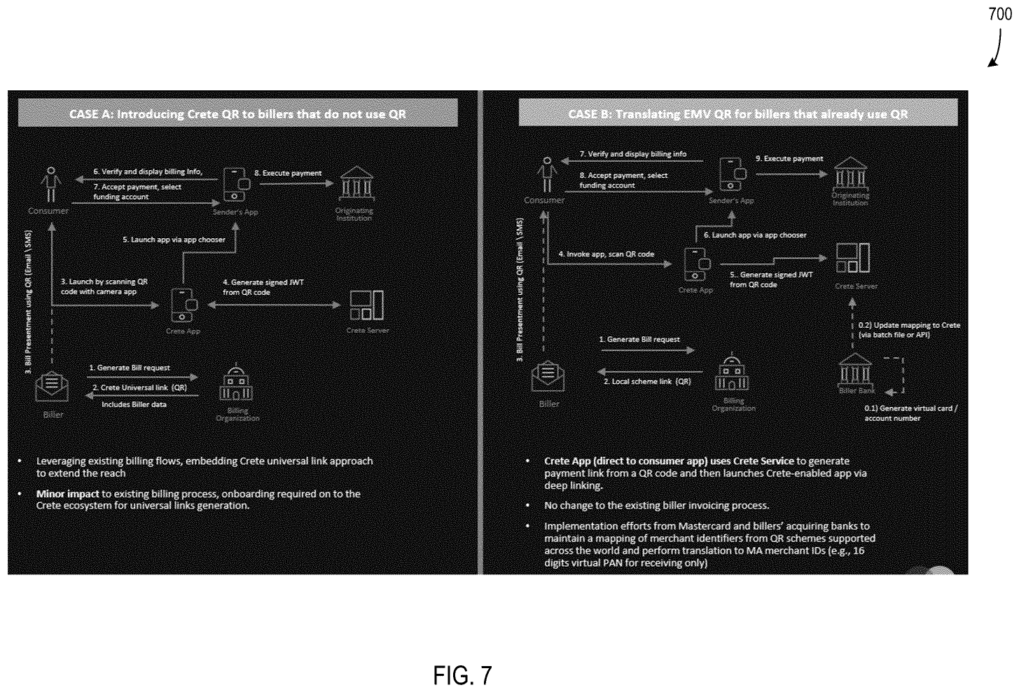

FIG. 7 is a diagram illustrating methods 700 for using QR codes with the described paylink service. In some examples, the methods 700 are executed or otherwise performed in a system such as system 100 of FIG. 1.

In some examples, the methods 700 include Case A, in which Paylink service QR codes are introduced to billers that do not use QR codes. Case A includes: generating a bill request; creating a paylink in the form of a QR code; presenting the bill using the QR code; launching a Paylink service app by scanning or otherwise using the QR code; generating a signed Java Web Token (JWT) from the QR code; launching an app via an app chooser; verifying and displaying the billing info to the consumer; accepting payment and selecting funding account by the consumer; and executing the payment.

Alternatively, or additionally, the methods 700 include Case B, in which Europay, Mastercard, and Visa (EMV) QR codes are translated for billers that already use QR codes. Case B includes: generating a bill request; generating a QR code using a local scheme link; presenting the bill information to the consumer using the QR code; invoking a Paylink service app upon scanning the QR code by the consumer; generating a signed JWT from the QR code by the Paylink service app; launching the sender's app via an app chooser; verifying and displaying the billing information to the consumer; accepting the payment and selecting funding account by the consumer; and executing the payment.

In some examples, the described methods include a method for paying a bill using a scannable Paylink service-based QR code. In some examples, the methods are executed or otherwise performed in a system such as system 100 of FIG. 1. In some examples, the method includes a payer using a camera of a device to scan a Paylink service QR code. Scanning the QR code activates the associated paylink and prompts the payer to select an app to use to process the bill payment. The payer selects a Paylink service-enabled app and selects to send the bill payment, such that the bill payment is processed and completed. The selected app notifies the payer that the bill payment is successful.

In some examples, the described methods include a method for paying a bill using a scannable EMV QR code and a Paylink service app. In some examples, the methods are executed or otherwise performed in a system such as system 100 of FIG. 1. In some examples, the method includes a payer using a camera of a device to scan an EMV QR code. A Paylink service app enables the payer to select to pay a bill and the camera app is launched based on this selection. Scanning the QR code activates the associated paylink and prompts the payer to select an app to use to process the bill payment. The payer selects a Paylink service-enabled app and selects to send the bill payment, such that the bill payment is processed and completed. The selected app notifies the payer that the bill payment is successful.

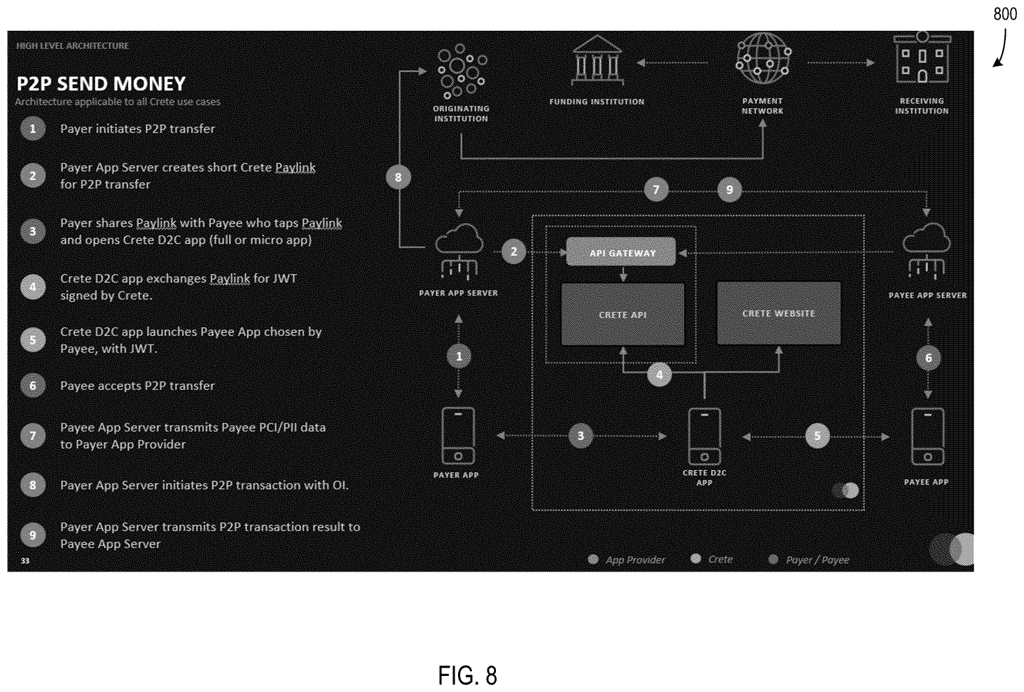

FIG. 8 is a diagram illustrating a method 800 for sending a P2P payment using the Paylink service. In some examples, the methods 800 are executed or otherwise performed in a system such as system 100 of FIG. 1.

In some examples, the method 800 includes the payer initiating a P2P transfer. The payer app server creates a paylink for P2P transfer. The payer shares the paylink with the payee, who activates the paylink and launches a Paylink service D2C app (e.g., a full app or micro app). The Paylink service D2C app exchanges the paylink for a JWT signed by Paylink service and then it launches a payee app chosen by the payee with the JWT. The payee accepts the P2P transfer. The payee app server transmits payee Payment Card Information (PCI)/Personally Identifiable Information (PII) data to the payer app provider. The payer app server initiates the P2P transaction with the OI and then transmits the transaction result to the payee app server.

In some examples, the described methods include a method for sending money by sharing a paylink using social channels. In some examples, the method is executed or otherwise performed in a system such as system 100 of FIG. 1. In some examples, the method includes a payer app creating a send money transfer and a payer app server generating a paylink JWT using a Paylink service public key. The paylink is provided to the Paylink service server and then the payer app provides the paylink to a Paylink service D2C app of the payee. When activated, the paylink is exchanged for a JWT signed by the Paylink service and the payee is prompted to choose a payee app for processing the payment. The chosen payee app is launched using the JWT and the JWT signature is verified with the Paylink service public key. The payment is accepted, and the send money transfer is updated with the payee data. The payee app server initiates the actual payment, and the transaction result is provided to the payer and the payee.

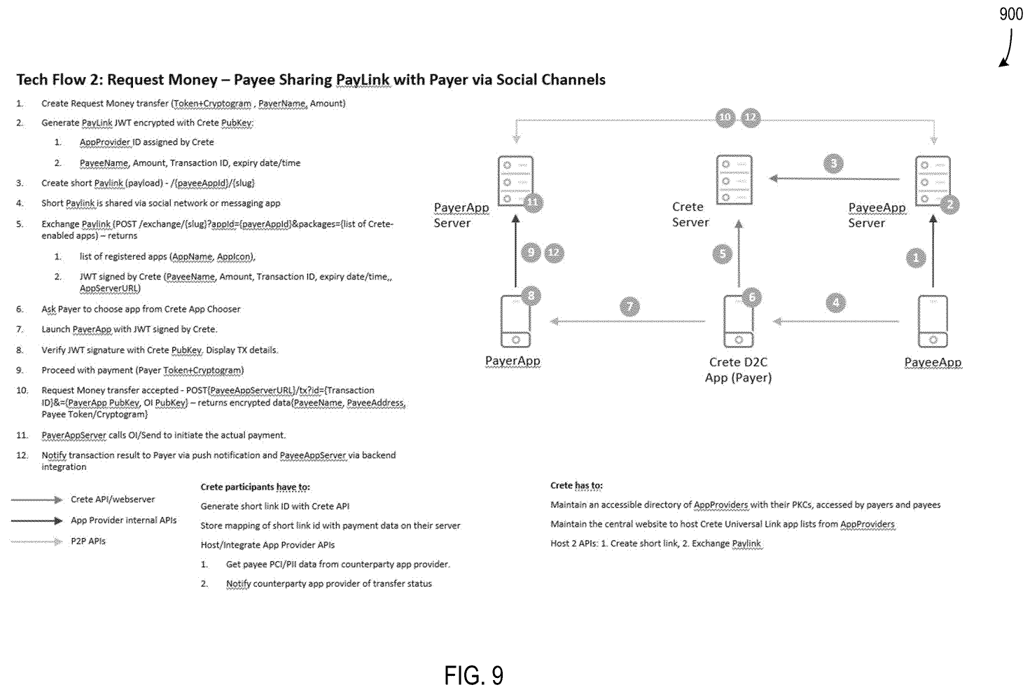

FIG. 9 is a diagram illustrating a method 900 for requesting money by sharing a paylink using social channels. In some examples, the methods 900 are executed or otherwise performed in a system such as system 100 of FIG. 1.

In some examples, the method 900 includes a payee app creating a request money transfer and a payee app server generating a paylink JWT using a Paylink service public key. The paylink is provided to the Paylink service server and then the payee app provides the paylink to a Paylink service D2C app of the payer. When activated, the paylink is exchanged by the Paylink service D2C app of the payer for a JWT signed by Paylink service and the payer is prompted to choose a payer app for processing the payment. The chosen payer app is launched using the JWT and the JWT signature is verified with the Paylink service public key. The payment is accepted, and the request money transfer is updated with the payer data. The payer app server initiates the actual payment, and the transaction result is provided to the payer and the payee.

In some examples, the described methods include a method for requesting money by scanning a QR code generated by a payee. In some examples, the method is executed or otherwise performed in a system such as system 100 of FIG. 1.

In some examples, the method includes a payee app creating a request money transfer and a payee app server generating a paylink JWT using a Paylink service public key. A QR code including the paylink is displayed, the payer scans the QR Code, and the data is provided to a Paylink service D2C app of the payer. When activated, the paylink is exchanged for a JWT signed by Paylink service and the payer is prompted to choose a payer app for processing the payment. The chosen payer app is launched using the JWT and the JWT signature is verified with the Paylink service public key. The payment is accepted, and the request money transfer is updated with the payer data. The payer app server initiates the actual payment, and the transaction result is provided to the payer and the payee.

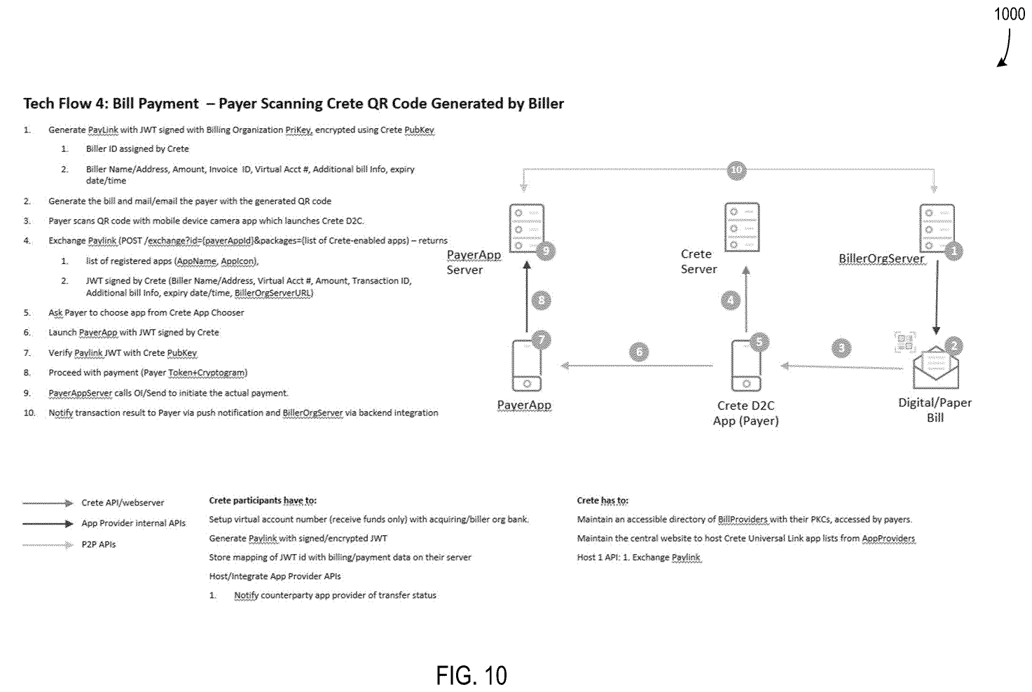

FIG. 10 is a diagram illustrating a method 1000 for paying a bill by scanning a Paylink service-based QR code generated by a biller. In some examples, the methods 1000 are executed or otherwise performed in a system such as system 100 of FIG. 1.

In some examples, the method 1000 includes a billing organization server generating a paylink with a JWT signed with the billing organization's private key. The data is then encrypted using the Paylink service public key. The bill is generated and sent to the payer, including a QR code associated with the paylink. The payer scans the QR code with a mobile device camera, which launches a Paylink service D2C app. The paylink is exchanged for a JWT signed by Paylink service and the payer is prompted to choose a payer app to be used. The chosen payer app is launched and the JWT is verified with the Paylink service public key. The payment process proceeds with the payer app server initiating the actual payment. A notification of the transaction result is sent to the payer and the bill organization server.

In some examples, the described methods include a method for paying a bill by scanning an EMV QR code generated by a biller. In some examples, the method is executed or otherwise performed in a system such as system 100 of FIG. 1.

In some examples, the method includes a billing organization server generating an EMV QR code including a merchant ID and/or other merchant information. The bill is generated and sent to the payer, including the QR code. The payer scans the QR code with a mobile device camera, which launches a Paylink service D2C app. The data of the QR code is exchanged for a JWT signed by Paylink service and the payer is prompted to choose a payer app to be used. The chosen payer app is launched and the JWT is verified with the Paylink service public key. The payment process proceeds with the payer app server initiating the actual payment. A notification of the transaction result is sent to the payer and the bill organization server.

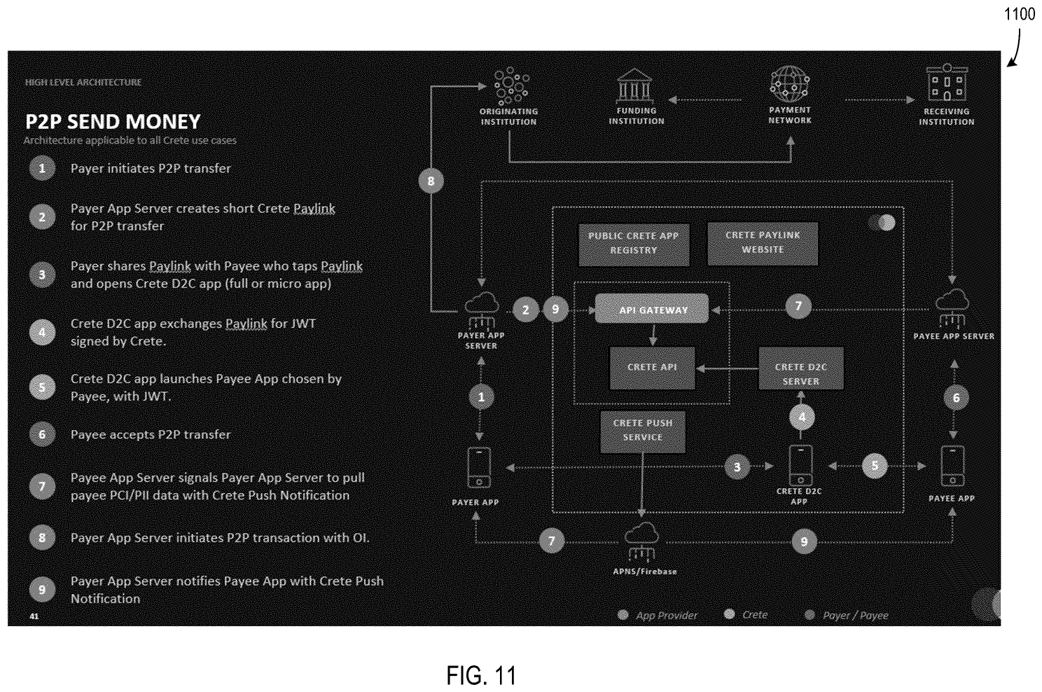

FIG. 11 is a diagram illustrating a method 1100 for sending a P2P payment using the Paylink service. In some examples, the methods 1100 are executed or otherwise performed in a system such as system 100 of FIG. 1.

In some examples, the method 1100 includes the payer initiating a P2P transfer. The payer app server creates a paylink for P2P transfer. The payer shares the paylink with the payee, who activates the paylink and launches a Paylink service D2C app (e.g., a full app or micro app). The Paylink service D2C app exchanges the paylink for a JWT signed by the Paylink service and then it launches a payee app chosen by the payee with the JWT. The payee accepts the P2P transfer. The payee app server signals the payer app server to pull PCI/PII data with a Paylink service Push Notification. The payer app server initiates the P2P transaction with OI and then transmits the transaction result to the payer app server. The payer app server notifies the payee app with Paylink service Push Notification.

Further, in some examples, the push service as described herein is configured to include necessary credentials to authenticate with servers associated with the device software providers so that it can create push notifications to applications belonging to third-party paylink-enabled applications. These push notifications are used to communicate events by Paylink service entities (e.g., involved in a transaction) to its counterparts. For instance, in an example, a Paylink payee application provider signals the Paylink payer application provider that a payment has been accepted and the payer server can pull its payee data to initiate the actual money transfer.

In some examples, the methods described herein include a method for sending money by sharing a paylink with the payee. In some examples, the method is executed or otherwise performed in a system such as system 100 of FIG. 1.

In some examples, the method includes a payer app creating a send money transfer and a payer app server generating a paylink JWT using a Paylink service public key. The paylink is provided to the Paylink service server and then the payer app provides the paylink to a Paylink service D2C app of the payee via social media and/or messaging app. When activated, the paylink is exchanged for a JWT signed by Paylink service and the payee is prompted to choose a payee app for processing the payment. The chosen payee app is launched using the JWT and the JWT signature is verified with the Paylink service public key. The payment is accepted, and the send money transfer is updated with the payee data. The payee app server initiates the actual payment, and the transaction result is provided to the payer via push notification and the payee via Paylink service Push service and/or associated API.

In some examples, the described methods include a method for requesting money by sharing a paylink with the payer. In some examples, the method is executed or otherwise performed in a system such as system 100 of FIG. 1.

In some examples, the method includes a payee app creating a request money transfer and a payee app server generating a paylink JWT using a Paylink service public key. The paylink is provided to the Paylink service server and then the payee app provides the paylink to a Paylink service D2C app of the payer via social media and/or a messaging app. When activated, the paylink is exchanged for a JWT signed by Paylink service and the payer is prompted to choose a payer app for processing the payment. The chosen payer app is launched using the JWT and the JWT signature is verified with the Paylink service public key. The payment is accepted, and the request money transfer is updated with the payer data. The payer app server initiates the actual payment, and the transaction result is provided to the payer via push notification and the payee via Paylink service Push API.

In some examples, the described methods include a method for requesting money by scanning a Paylink service-based QR code generated by the payee. In some examples, the method is executed or otherwise performed in a system such as system 100 of FIG. 1.

In some examples, the method includes a payee app creating a request money transfer and a payee app server generating a paylink JWT using a Paylink service public key. A QR code including the paylink is displayed, the payer scans the QR Code, and the data is provided to a Paylink service D2C app of the payer. When activated, the paylink is exchanged for a JWT signed by Paylink service and the payer is prompted to choose a payer app for processing the payment. The chosen payer app is launched using the JWT and the JWT signature is verified with the Paylink service public key. The payment is accepted, and the request money transfer is updated with the payer data. The payer app server initiates the actual payment, and the transaction result is provided to the payer via push notification and the payee via Paylink service Push API.

### Exemplary Operating Environment

The present disclosure is operable with a computing apparatus according to an embodiment as a functional block diagram 1200 in FIG. 12. In an example, components of a computing apparatus 1218 are implemented as a part of an electronic device according to one or more embodiments described in this specification. The computing apparatus 1218 comprises one or more processors 1219 which may be microprocessors, controllers, or any other suitable type of processors for processing computer executable instructions to control the operation of the electronic device. Alternatively, or in addition, the processor 1219 is any technology capable of executing logic or instructions, such as a hardcoded machine. In some examples, platform software comprising an operating system 1220 or any other suitable platform software is provided on the apparatus 1218 to enable application software 1221 to be executed on the device. In some examples, enabling peer-to-peer record change requests to be processed and associated record operations to be performed as described herein is accomplished by software, hardware, and/or firmware.

In some examples, computer executable instructions are provided using any computer-readable media that are accessible by the computing apparatus 1218. Computer-readable media include, for example, computer storage media such as a memory 1222 and communications media. Computer storage media, such as a memory 1222, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1222) is shown within the computing apparatus 1218, it will be appreciated by a person skilled in the art, that, in some examples, the storage is distributed or located remotely and accessed via a network or other communication link (e.g., using a communication interface 1223).

Further, in some examples, the computing apparatus 1218 comprises an input/output controller 1224 configured to output information to one or more output devices 1225, for example a display or a speaker, which are separate from or integral to the electronic device. Additionally, or alternatively, the input/output controller 1224 is configured to receive and process an input from one or more input devices 1226, for example, a keyboard, a microphone, or a touchpad. In one example, the output device 1225 also acts as the input device. An example of such a device is a touch sensitive display. The input/output controller 1224 may also output data to devices other than the output device, e.g., a locally connected printing device. In some examples, a user provides input to the input device(s) 1226 and/or receives output from the output device(s) 1225.

The functionality described herein can be performed, at least in part, by one or more hardware logic components. According to an embodiment, the computing apparatus 1218 is configured by the program code when executed by the processor 1219 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCS, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to, with the processor, cause the processor to: receive a link from a first application, the link being associated with a record change request from a first account; obtain a signed token from a link service using the link, wherein the signed token includes identity data associated with the first account and the record change request; receive an indicator of a second application chosen by a user for interacting with the record change request and account information of a second account associated with the user; and cause the second application to be executed using the signed token and the indicator of the second application, wherein the second application updates a record at the second account associated with the user in response to the record change request.

An example computerized method comprises receiving a link from a first application, the link being associated with a record change request from a first account; obtaining a signed token from a link service using the link, wherein the signed token includes identity data associated with the first account and the record change request; receiving an indicator of a second application chosen by a user for interacting with the record change request and account information of a second account associated with the user; and causing the second application to be executed using the signed token and the indicator of the second application, wherein the second application updates a record at the second account associated with the user in response to the record change request.

One or more computer storage media having computer-executable instructions that, upon execution by a processor, cause the processor to at least: receive a link from a first application, the link being associated with a record change request from a first account; obtain a signed token from a link service using the link, wherein the signed token includes identity data associated with the first account and the record change request; receive an indicator of a second application chosen by a user for interacting with the record change request and account information of a second account associated with the user; and cause the second application to be executed using the signed token and the indicator of the second application, wherein the second application updates a record at the second account associated with the user in response to the record change request.

Alternatively, or in addition to the other examples described herein, examples include any combination of the following:
wherein the first application is of a first application type and the second application is of a second application type and wherein the first application type and the second application type are not compatible.
further comprising: displaying the link to the user using an interface of a user device; and receiving an indication from the interface that the link has been activated, wherein obtaining the signed token is based on the link being activated.
further comprising: displaying at least one application that is compatible with the link service using an interface of a user device; and prompting the user to select an application from the displayed at least one application, wherein the second application indicator is received in response to the prompt.
wherein receiving the link includes scanning a QR code that includes data of the link with an optical device of a user device.
wherein obtaining the signed token using the received link, receiving the indicator of the second application, and causing the chosen second application to be executed is performed using a website associated with a paylink service.
wherein obtaining the signed token using the received link, receiving the indicator of the second application, and causing the chosen second application to be executed is performed using a link service application.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for receiving a link from a first application, the link being associated with a record change request from a first account; exemplary means for obtaining a signed token from a link service using the link, wherein the signed token includes identity data associated with the first account and the record change request; exemplary means for receiving an indicator of a second application chosen by a user for interacting with the record change request and account information of a second account associated with the user; and exemplary means for causing the second application to be executed using the signed token and the indicator of the second application, wherein the second application updates a record at the second account associated with the user in response to the record change request.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
receive a link from a first application, the link being associated with a record change request from a first account;
obtain a signed token from a link service using the link, wherein the signed token includes identity data associated with the first account and the record change request;
receive an indicator of a second application chosen by a user for interacting with the record change request and account information of a second account associated with the user; and
cause the second application to be executed using the signed token and the indicator of the second application, wherein the second application updates a record at the second account associated with the user in response to the record change request.

2. The system of claim 1, wherein the first application is of a first application type and the second application is of a second application type and wherein the first application type and the second application type are not compatible.

3. The system of claim 1, wherein the computer program code is configured to, with the processor, further cause the processor to:
display the link to the user using an interface of a user device; and
receive an indication from the interface that the link has been activated, wherein obtaining the signed token is based on the link being activated.

4. The system of claim 1, wherein the computer program code is configured to, with the processor, further cause the processor to:
display at least one application that is compatible with the link service using an interface of a user device; and
prompt the user to select an application from the displayed at least one application, wherein the second application indicator is received in response to the prompt.

5. The system of claim 1, wherein receiving the link includes scanning a QR code that includes data of the link with an optical device of a user device.

6. The system of claim 1, wherein obtaining the signed token using the received link, receiving the indicator of the second application, and causing the chosen second application to be executed is performed using a website associated with a paylink service.

7. The system of claim 1, wherein obtaining the signed token using the received link, receiving the indicator of the second application, and causing the chosen second application to be executed is performed using a link service application.

8. A computerized method comprising:
receiving a link from a first application, the link being associated with a record change request from a first account;
obtaining a signed token from a link service using the link, wherein the signed token includes identity data associated with the first account and the record change request;
receiving an indicator of a second application chosen by a user for interacting with the record change request and account information of a second account associated with the user; and
causing the second application to be executed using the signed token and the indicator of the second application, wherein the second application updates a record at the second account associated with the user in response to the record change request.

9. The computerized method of claim 8, wherein the first application is of a first application type and the second application is of a second application type and wherein the first application type and the second application type are not compatible.

10. The computerized method of claim 8, further comprising:
displaying the link to the user using an interface of a user device; and
receiving an indication from the interface that the link has been activated, wherein obtaining the signed token is based on the link being activated.

11. The computerized method of claim 8, further comprising:
displaying at least one application that is compatible with the link service using an interface of a user device; and
prompting the user to select an application from the displayed at least one application, wherein the second application indicator is received in response to the prompt.

12. The computerized method of claim 8, wherein receiving the link includes scanning a QR code that includes data of the link with an optical device of a user device.

13. The computerized method of claim 8, wherein obtaining the signed token using the received link, receiving the indicator of the second application, and causing the chosen second application to be executed is performed using a website associated with a paylink service.

14. The computerized method of claim 8, wherein obtaining the signed token using the received link, receiving the indicator of the second application, and causing the chosen second application to be executed is performed using a link service application.

15. One or more computer storage media having computer-executable instructions that, upon execution by a processor, cause the processor to at least:
receive a link from a first application, the link being associated with a record change request from a first account;
obtain a signed token from a link service using the link, wherein the signed token includes identity data associated with the first account and the record change request;
receive an indicator of a second application chosen by a user for interacting with the record change request and account information of a second account associated with the user; and
cause the second application to be executed using the signed token and the indicator of the second application, wherein the second application updates a record at the second account associated with the user in response to the record change request.

16. The one or more computer storage media of claim 15, wherein the first application is of a first application type and the second application is of a second application type and wherein the first application type and the second application type are not compatible.

17. The one or more computer storage media of claim 15, wherein the computer-executable instructions, upon execution by a processor, further cause the processor to at least:
display the link to the user using an interface of a user device; and
receive an indication from the interface that the link has been activated, wherein obtaining the signed token is based on the link being activated.

18. The one or more computer storage media of claim 15, wherein the computer-executable instructions, upon execution by a processor, further cause the processor to at least:
display at least one application that is compatible with the link service using an interface of a user device; and
prompt the user to select an application from the displayed at least one application, wherein the second application indicator is received in response to the prompt.

19. The one or more computer storage media of claim 15, wherein receiving the link includes scanning a QR code that includes data of the link with an optical device of a user device.

20. The one or more computer storage media of claim 15, wherein obtaining the signed token using the received link, receiving the indicator of the second application, and causing the chosen second application to be executed is performed using a website associated with a paylink service.
